(19) United States
(12) Patent Application Publication
(10) Pub. No.: US 2014/0006776 A1
(43) Pub. Date: Jan. 2, 2014

(54) CERTIFICATION OF A VIRTUAL TRUSTED PLATFORM MODULE

(71) Applicants: Mark Scott-Nash, Boulder, CO (US); Alberto Munoz, Los Altos, CA (US); Simon Johnson, Beaverton, OR (US); Asher Altman, Bedford, MA (US)

(72) Inventors: Mark Scott-Nash, Boulder, CO (US); Alberto Munoz, Los Altos, CA (US); Simon Johnson, Beaverton, OR (US); Asher Altman, Bedford, MA (US)

(21) Appl. No.: 13/537,329

(22) Filed: Jun. 29, 2012

(51) Int. Cl. G06F 21/00; H04L 29/06

(52) U.S. Cl. 713/156; 713/189

(57) ABSTRACT

A technique includes on a physical platform, providing a supervisor to manage a lifecycle of a virtual trusted platform module. The technique includes using the supervisor to sign a certificate for an attestation identity key used by the virtual trusted platform module.

### BACKGROUND

A typical computer may contain a trusted platform module (TPM), which typically is an integrated circuit that includes a cryptographic processor and a secure memory. The TPM typically forms the root of trust for the computer in conjunction with the computer's basic input/output system (BIOS). In this regard, the TPM may be regarded as a root of trust for reporting and a root of trust for storage, in that the TPM securely stores various cryptographic keys and measurements of the computer's software and hardware configurations (as measured by the BIOS).

### BRIEF DESCRIPTION OF THE DRAWINGS

FIG. 1 is a schematic diagram of a processor-based machine according to an example implementation.

FIG. 2 is a schematic diagram of a virtual trusted platform module architecture according to an example implementation.

FIG. 3 is an illustration of the relationship of the virtual trusted platform module, a virtual trusted platform module supervisor and secure enclaves according to an example implementation.

FIG. 4 is a schematic diagram of a direct attestation architecture according to an exemplary implementation.

FIG. 5 is a flow diagram depicting a technique to use a virtual trusted platform module supervisor to sign a certification of attestation for a virtual trusted platform module according to an exemplary implementation.

FIG. 6 is a schematic diagram of an example certification of virtual trusted platform module identity keys using a group private key in a cloud environment according to an exemplary implementation.

FIG. 7 is an example of the use of supervisor key signed attestation identity credentials in a cloud environment according to an exemplary implementation.

### DETAILED DESCRIPTION

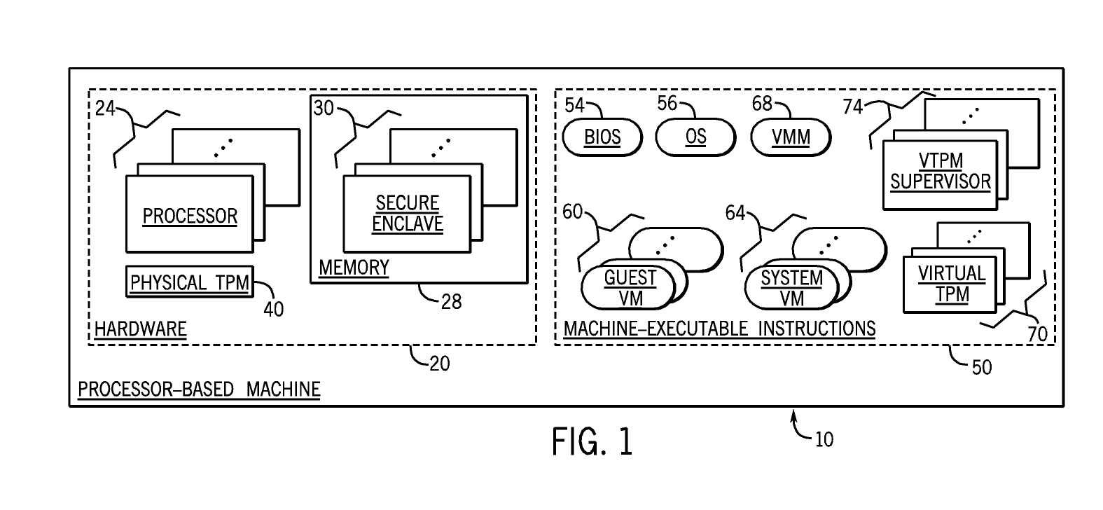

Referring to FIG. 1, a hardware platform, such as processor-based machine 10, may include a physical trusted platform module (TPM) 40 (herein called the “physical TPM 40”). In general, the physical TPM 40 is a hardware device (an integrated circuit, which may be contained in a semiconductor package, or “chip,” as an example) that includes a cryptographic processor and a secure memory. The physical TPM 40 forms the roots of trust for reporting and storage for the processor-based machine 10. In this regard, the secure memory of the physical TPM 40 stores cryptographic keys as well as measurements for the processor-based machine 10, which are acquired and written to the physical TPM 40 by a basic input/output system (BIOS) 54 of the machine 10, in accordance with some implementations.

As non-limiting examples, the processor-based machine 10 may be a desktop computer; a portable computer; a tablet computer; a server; a wide area network (WAN) server; an Internet-based server; a cloud server; a client; a thin client; a cellular telephone; a smartphone; or in general, any machine that includes at least one processor 24 (a microprocessor, a microcontroller, a processing core of such a microprocessor or microcontroller, and so forth). Regardless of its particular form, the processor-based machine 10 is a physical machine that is formed from a physical platform, or physical hardware 20, and machine executable instructions 50, or software, in accordance with example implementations.

In addition to the physical TPM 40 and the processor(s) 24, the processor-based machine 10 may contain various other physical hardware components, such as, for example, components that form a memory 28 of the machine 10. In general, the memory 28 may be a system memory, a cache memory, a microprocessor-based memory, a memory internal to a processor 24, a memory external to a processor 24, a combination of such memories, and so forth, depending on the particular implementation. Moreover, the memory 28 is a non-transitory memory and may be formed from such memory devices as semiconductor devices, optical storage devices, phase change memory devices, magnetic storage devices, and so forth. One or more (even all) of the hardware components of the processor-based machine 10 may be part of the same integrated circuit or may be parts of intercoupled integrated circuits, depending on the particular implementation.

As further disclosed herein, the processor-based machine 10 may have one or more virtual components, in accordance with example implementations. In this manner, the processor-based machine 10 may include a hypervisor, or virtual machine monitor (VMM) 68, that virtualizes the machine's hardware 20 to provide virtual operating platforms to allow guest virtual machines (herein called “guest VMs 60”) to execute, or run, concurrently on the machine 10. Thus, in general, each guest VM 60 is unaware of the existence of the other guest VM(s) 60, and each guest VM 60 perceives its virtual operating platform as a physical platform.

A given guest VM 60, during its course of operation, may receive a request from a verifier, for attestation of the guest VM's virtual platform. More specifically, as further described herein, the verifier requests a virtualized TPM (called a “virtual TPM” herein) to attest for the guest VM 60. The verifier may be an entity (an application or an Internet server, as examples) that is external to the processor-based machine 10 and may or may not be a trusted third party. For purposes of providing sufficient proof to the verifier, the guest VM 60 may rely on a virtualized version of the physical TPM 40 to provide the information to attest to the VM's authenticity.

One way to virtualize the physical TPM 40 is for the physical TPM 40 to securely store the secrets (keys, measurements, certificates and so forth) for the guest VMs 60, so that the physical TPM 40 may be used to attest to a given guest VM's authenticity. However, reliance on such a scheme may be relatively challenging, as the physical TPM 40 may be relatively incapable of serving more than one platform and providing the appropriate security to partition the stored secured data among the guest VMs 60. Moreover, for such an approach, a high degree of trust is afforded to the VMM 68, as the VMM 68 has access to the secrets of all of the guest VMs 60. Lastly, such an approach may be challenging for migration purposes due to the relatively difficult and resource consuming challenges of migrating secrets between physical TPMs that reside on different physical platforms when guest VMs are migrated between those platforms.

In accordance with the systems and techniques that are disclosed herein, the processor-based machine 10 virtualizes the physical TPM 40 for its guest VMs 60 using one or multiple virtual trusted platform modules (TPMs) 70 (herein called “virtual TPMs 70”). The virtual TPM 70, in turn, may be used to provide information to a requesting verifier to attest to the authenticity of an associated guest VM 60.

The virtual TPMs 70 may be viewed as virtualized versions of the physical TPM 40 for the guest VMs 60: each virtual TPM 70 serves as the roots of trust for measurement and storage for an associated guest VM 60. In accordance with example implementations that are disclosed herein, the processor-based machine 10 bind a given virtual TPM 70 to a given guest VM 60. After a given virtual TPM 70 is bound to a given guest VM 60, the processor-based machine 10 does not re-assign the given virtual TPM 70 to another guest VM 60, regardless of whether the originally-assigned guest VM 60 is migrated or retired.

In accordance with the systems and techniques that are disclosed herein, the virtual TPM 70 is contained within a secure enclave 30 of the processor-based machine 10. The secure enclave 30 protects the secrets of the virtual TPM 70 without involving the direct use of the physical TPM 40; and the secure enclave 30 protects the secrets of the virtual TPM 70 from the firmware, the VMM 68 and other processes that are running, or executing, on the processor-based machine 10.

In general, a secure enclave 30 is a set of memory locations that provides a safe place for an application to execute program instructions and store data inside the enclave 30 in the context of an operating system (OS) process. Thus, an application that executes in this environment is called an “enclave.” Enclaves are executed from an enclave page cache, and the enclave pages are loaded into the enclave page cache by an operating system. Whenever a page of a secure enclave 30 is removed from the enclave page cache, cryptographic protections are used to protect the confidentiality of the page and to detect tampering when the page is loaded back into the enclave page cache. Inside the enclave page cache, enclave data is protected using access control mechanisms, which are provided by the processor(s) 24, and the pages of the page cache are also encrypted.

In general, the enclave page cache is where enclave code is temporarily stored in its encrypted state. The enclave code is fetched from the enclave page cache, decrypted and placed in the processor cache where the code is retrieved and executed in the same manner as non-enclave code, and where enclave data is accessed by the processor 24. Thus, in general, the hardware of the processor-based machine 10 provides a mechanism for protecting certain memory locations, and as described herein, this mechanism is used to protect the virtual TPMs 70. In general, the enclave page cache may be located within the physical address space of the processor-based machine 10, and the enclave page cache may be accessed solely through the use of secure enclave instructions, which are a subset of instructions executed by the processor(s) 24. It is noted that the enclave page cache may contain pages from many different secure enclaves 30 and may provide access control mechanisms to protect the integrity and confidentiality of the pages. The enclave page cache maintains a coherency protocol similar to the one used to preserve coherent physical memory accesses in the processor-based machine 10.

The enclave page cache uses an enclave page cache map, which contains the state information associated with each page in the enclave page cache. The state information indicates information such as the particular enclave 30 to which a given page belongs, the state of a loaded page, and so forth. When a page is removed from the enclave page cache, the state information is exported from the enclave page cache map as well as protected using cryptographic means. Similarly, when a given enclave page is re-loaded into the enclave page cache, the state information is verified.

It is noted that the enclave page cache may be stored in many different types of memories, depending on the particular implementation. For example, in accordance with some implementations, the enclave page cache may be stored on board static random access memory (SRAM) of a given processor 24. As another example, the enclave page cache may be stored as part of a dynamic random access memory (DRAM) that is disposed on the processor 24 or disposed separately from the processor 24. The enclave page cache may also be constructed by dynamically sequestering ways of the processor's last-level cache. For these implementations, the enclave page cache may be protected from unauthorized accesses from outside the processor package, while allowing other packages in the system to access the enclave page cache coherently yet securely.

In further implementations, the enclave page cache may be a cryptographic memory aperture, which may provide a relatively cost-effective mechanism of creating cryptographically-protected volatile storage using DRAM. In this manner, the cryptographic memory aperture uses one or more strategically-placed cryptographic units in a region outside of a processing core of the processor 24 (when the processor 24 is a central processing unit (CPU), for example) to provide varying levels of protection. The various uncore agents are modified to recognize the memory accesses going to the cryptographic memory aperture and to route these accesses to a cryptographic controller located in the uncore. The cryptographic controller, depending on the desired protection level, generates one or more memory accesses to the platform DRAM to fetch the cipher text. The fetch text is then processed by the cryptographic controller to generate the plain text to satisfy the original cryptographic memory aperture request.

In accordance with some implementations, the enclave page cache is kept as a separate container, which is managed by microcode of a processor 24. In this manner, the container is not accessible when execution is outside of the secure enclave 30. When the secure enclave 30 is entered, control is transferred to the enclave code inside the enclave page cache, which is contained in a separate container.

Any page faults or exceptions that occur while executing inside of the enclave 30 are reflected by the microcode to the responsible operating system or VMM. When the processor-based machine 10 is executing outside of any of the enclaves 30, access control to the enclave page cache may be provided by a secure enclave range register of the processor 24. In this manner, the processor-based machine 10, when running inside the microcode, provides page table level protections that prevent access to other enclave page cache entries that do not belong to the executing secure enclave 30. Thus, one option to implement the secure enclaves 30 is to implement the instructions and the protections using the microcode capability of the processor 24.

More details about example implementations of the secure enclave 30 may be found, for example, in PCT Publication No. WO 2011/078855 A1, entitled, “METHOD AND APPARATUS TO PROVIDE SECURE APPLICATION EXECUTION,” which published on Jun. 30, 2011.

As further described below, a given virtual TPM 70 is initialized using certain values that uniquely describe the virtual TPM 70 (and allows the virtual TPM 70 to present itself as a valid virtual TPM) and provide information about the trust state of the underlying physical platform. The virtual TPM 70 may be provisioned by assigning keys to an initialized virtual TPM 70, as also further described below, and thereafter, the provisional virtual TPM 70 may be assigned to one of the guest VMs 60.

In addition to the guest VMs 60, VMM 68, BIOS 54 and virtual TPMs 70, the machine executable instructions 50, or software, of the processor-based machine 10 may further include such other instructions 50, as instructions 50 that when executed, form a host operating system 56 and system VMs 64, which control the provisioning and creation of the guest VMs 60, as further described below. Moreover, as depicted in FIG. 1, the machine executable instructions 50 also include one or multiple virtual TPM supervisors 74, which, as further disclosed herein, are associated with given virtual TPMs 70 and are contained in the secure enclaves 30 to manage the life cycles of the virtual TPMs 70. In accordance with some implementations, a virtual TPM supervisor 74 is associated with a physical platform and manages all of the virtual TPMs 70 residing in that platform at a given time.

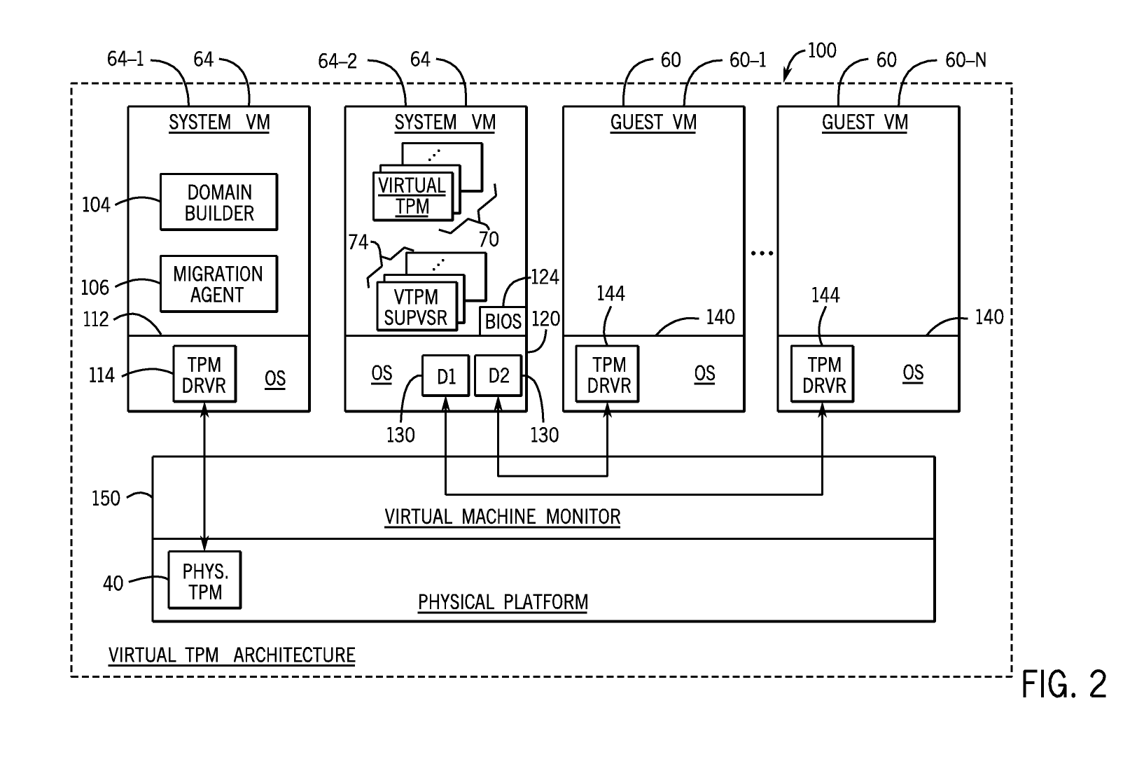

Referring to FIG. 2 in conjunction with FIG. 1, as a more specific example, in an exemplary implementation, the processor-based machine 10 may employ a virtual TPM architecture 100. The virtual TPM architecture 100 includes one or multiple system VMs 64 (system VMs 64-1 and 64-2 being depicted in FIG. 2 as examples), which, in general, provide system level control of the guest VMs 60 (guest VMs 60-1 . . . 60-N being depicted in FIG. 2 as examples). In this manner, as an example, the system VMs 64 may perform such system level control functions as managing, building and migrating the guest VMs 60. As depicted in FIG. 2, the system VM 64-1 may contain such components as a guest operating system 112, which contains a TPM driver 114 for purposes of allowing the operating system 112 to communicate with the physical TPM 40. The system VM 64-1 further includes a domain builder 104, which initializes the environments for the guest VMs 60. In this manner, the domain builder 104 may perform such functions as initializing the guest operating systems for the guest VMs 60, allocating memory for the guest VMs 60, and so forth.

The system VM 64-1 may also include a migration agent 106, which, as its name implies, manages guest VM migration. In this manner, the migration agent 106 may, for example, manage the copying of a guest VM 60 from the processor-based machine 10 to another physical platform to which the guest VM 60 is being migrated and deletes a copy of a guest VM 60 after the guest VM 60 has been migrated.

The system VM 64-2, in accordance with example implementations, contains the virtual TPMs 70 as well as the virtual TPM supervisors 74. The system VM 64-2 contains a guest operating system 120, as well as a guest basic input-output-operating system (BIOS) 124. The guest operating system 120, in turn, includes drivers 130, which permit communication between a given guest VM 60 and virtual TPM 70 pair. In this manner, each guest VM 60 contains a TPM driver 144 (part of the guest operating system 140 of the guest VM 60), which establishes communication (through the VMM 68) between the guest VM 60 and its assigned virtual TPM 70.

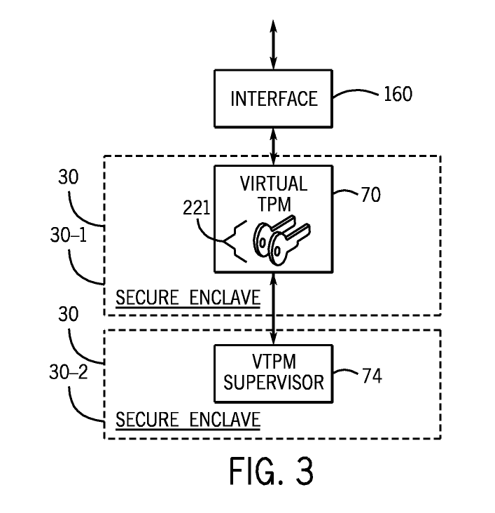

Referring to FIG. 3 in conjunction with FIG. 2, in accordance with exemplary implementations, a given virtual TPM 70 and its associated virtual TPM supervisor 74 are each contained within an associated secure enclave 30. Thus, in accordance with some implementations, each virtual TPM 70 (depicted as being contained within a secure enclave 30-1 in FIG. 3) and each virtual TPM supervisor 74 (depicted as being contained within a secure enclave 30-2 in FIG. 3) may be contained within its own associated secure enclave 30. It is noted that the depiction in FIG. 3 is simplified, in that more than one virtual TPM 70 may be associated with a given virtual TPM supervisor 74. Moreover, as shown in FIG. 3, the entities outside of its secure enclave 30 communicated with the virtual TPM 70 via a software interface 160. Thus, in accordance with some implementations, the guest VM 60 (which “owns” a given virtual TPM 70) communicates with the virtual TPM 70 via the interface 160 and a given driver 130

The virtual TPM 70 stores private keys 221, which are stored in the virtual TPM 70 when the TPM 70 is provisioned. As a more specific example, a given key 221 may be a private key of a private and public key pair, which uniquely identifies the virtual TPM 70. The keys 221 of the virtual TPM 70, in accordance with example implementations, do not venture beyond the boundaries of the associated secure enclave 30. In this manner, the virtual TPM 70 carries secure information, such as the keys 221 and certificates signed with the keys 221, between platforms and is migrated as its associated guest VM 60 is migrated.

As a more specific example, the keys 221 of a given virtual TPM 70 may include a private key of a public and private key Rivest-Shamir-Adleman (RSA) key pair, which uniquely identifies the virtual TPM 70. The virtual TPM 70 may further store a private key of a private and public attestation key pair, which is used for purposes of authenticating the virtual TPM 70 (and its associated guest VM 60) to a requesting verifier. Moreover, the virtual TPM 70 may further store various certificates, such as certificates signed by associated attestation identity keys, and so forth.

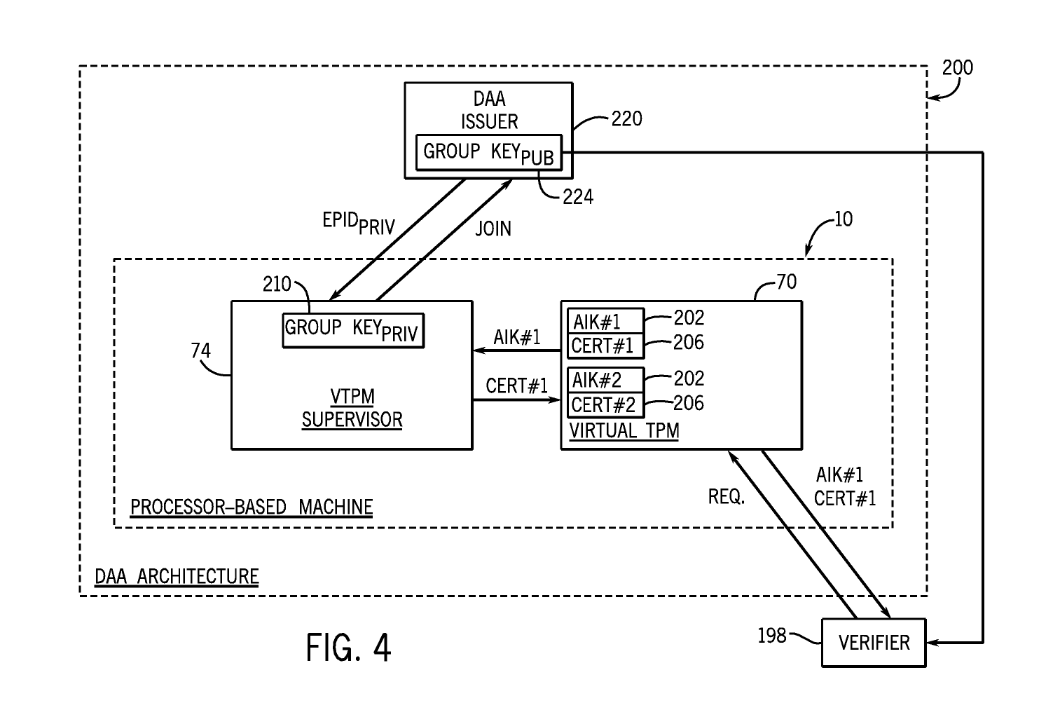

Referring to FIG. 4, in accordance with exemplary implementations disclosed herein, a direct anonymous attestation (DAA) architecture 200 is used for purposes of remotely and anonymously authenticating a hardware device. More specifically, as disclosed herein, a verifier 198 may request the virtual TPM 70 to attest for the virtual TPM's owner, its virtual platform.

For purposes of preserving the privacy of the processor-based machine 10 (and users that use the processor-based machine 10), the DAA architecture 200 employs the use of group private and public identity keys. As an example, in accordance with some implementations, the group private and public keys may be a private key-public key pair of Intel Corporation's cryptographic scheme called, “Enhanced Privacy Identification (EPID).” As described in the examples below, in accordance with some implementations, the TPM 70 stores a private group identity key 210 of a private-public group identity key pair, which is formed from the private group identity key 210 and a public group identity key 224.

The private-public group identity key pair permits the virtual TPM 70 to prove to the verifier 198 that the TPM 70 is a valid device made and certified by the given hardware manufacturer, without revealing the identity of the virtual TPM 70 and without the verifier 198 being able to link multiple authentication attempts made by the TPM 70.

More specifically, in accordance with example implementations, the virtual TPM 70 responds to a given authentication request from the verifier 198 with an attestation identification key (AIK) and an attestation identification certificate (AIC), which is signed using the private group identity key 210. The verifier 198, in response to receiving the AIK and the corresponding AIC, verifies that the virtual TPM 70 is an authentic device made by the given hardware manufacturer through the use of the public group identity key 224.

More specifically, for the given example of FIG. 4, in response to a request from the verifier 198 for the virtual TPM 70 to attest for the virtual platform, the virtual TPM 70 may provide an AIK called “AIK#1” 202 and an associated AIC called “CERT#1” 206. In general, the virtual TPM 70 may store multiple AIKs, as illustrated by AIK#1 202, AIK#2 202, and so forth. Each of these AIKs, in turn, has an associated signed AIC, such as CERT#1 206, CERT#2 206, and so forth.

The use of the public-private group identity key pair for purposes of remotely and anonymously certifying the virtual TPM 70 works as follows. A given public group identity key 224 may be associated with many private group identity keys 210, with each public-private key pair forming a unique identification. It is noted that a private group identity key 210 may join a given group of virtual TPMs 70 at provisioning time of the virtual TPMs 70 after the processor-based system 10 has been deployed.

For the example that is depicted in FIG. 4, a DAA issuer 220 makes a public group identity key 224 publically available for a given public key-private key pair. The private group identity key 210, in turn, is provided to a requesting platform (via a join request). It is noted that the DAA issuer 220 is remotely disposed with respect to the processor-based machine 10. As a non-limiting example, the DAA issuer 220 may be associated with the manufacturer of a platform chipset.

As depicted in FIG. 4, the virtual TPM supervisor 74 may request the private group identity key 210 and subsequently store the key 210 so that the supervisor 74 may sign attestation certificates for its associated virtual TPMs 70. In this manner, using the stored private group identity key 210, the virtual TPM supervisor 74 may then sign corresponding AICs for AIKs for a corresponding group of virtual TPMs 70. It is noted that FIG. 4 is a simplified diagram representing a single platform and a single virtual TPM 70 on that platform, although, the virtual TPM supervisor 74 may sign the certificates for multiple virtual TPMS 70 of the platform, in accordance with some implementations.

A signed AIC makes the following statements: the virtual TPM 70 containing the AIC was created within a secure enclave 30 by a virtual TPM supervisor 74 using the public-private group identity key infrastructure; the identity represented by the AIK is a specified security version of a virtual TPM 70; and the identity represented by the AIK is private based on an public-private group identity privacy analysis.

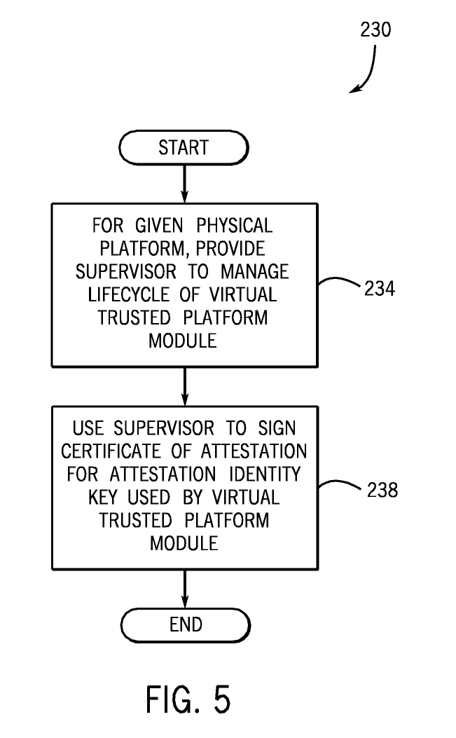

Thus, referring to FIG. 5, in accordance with example implementations, a technique 230 includes, for a given physical platform, providing a supervisor to manage the life cycle of a virtual trusted platform module, pursuant to block 234. The supervisor is used (block 238) to sign a certificate of attestation for an attestation identity key that is used by the virtual trusted platform module, to fulfill an attestation request from a verifier, pursuant to block 238.

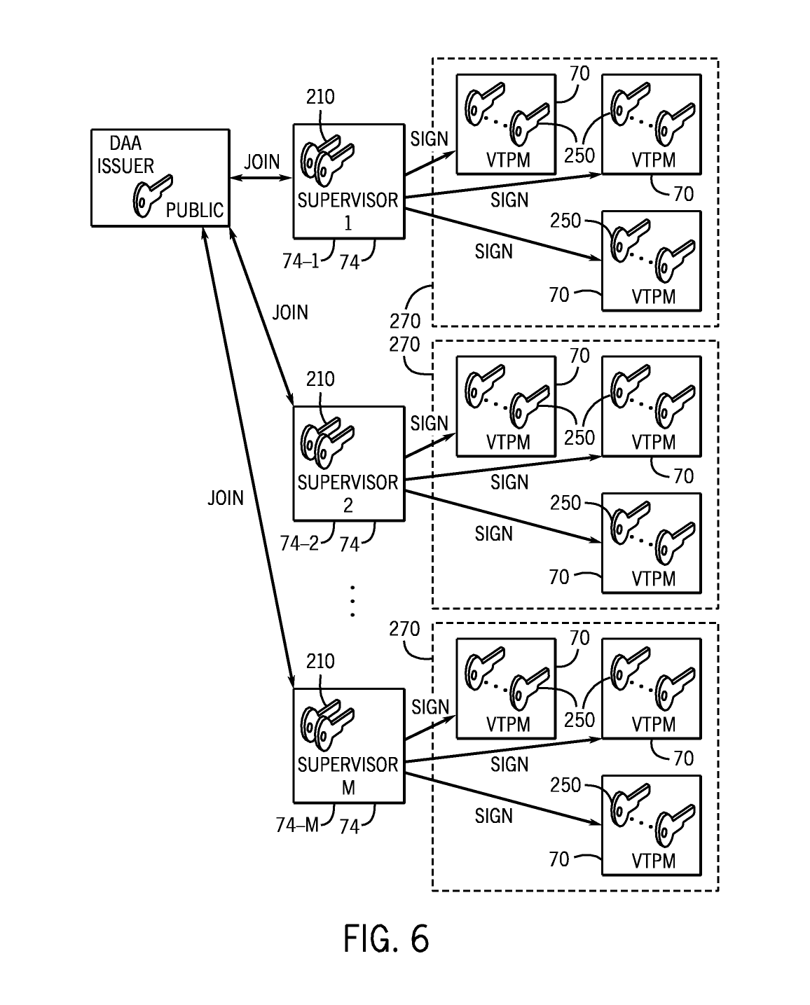

Referring to FIG. 6, in a cloud environment, virtual TPM supervisors 74 (virtual TPM supervisors 74-1, 74-2 . . . 74-M, being depicted in FIG. 6 as examples) reside on separate physical platforms and collectively serve as a distributed certificate authority (CA). In this manner, a given virtual TPM supervisor 74 may sign multiple AICs for a given virtual TPM 70 and may sign AICs for multiple virtual TPMs 70 under its supervision. FIG. 6 in general illustrates a cloud environment in which multiple virtual TPM supervisors 74 have associated groups 270 and use their respective private group identity keys to sign AICs for the various virtual TPMs 70 in their groups 250.

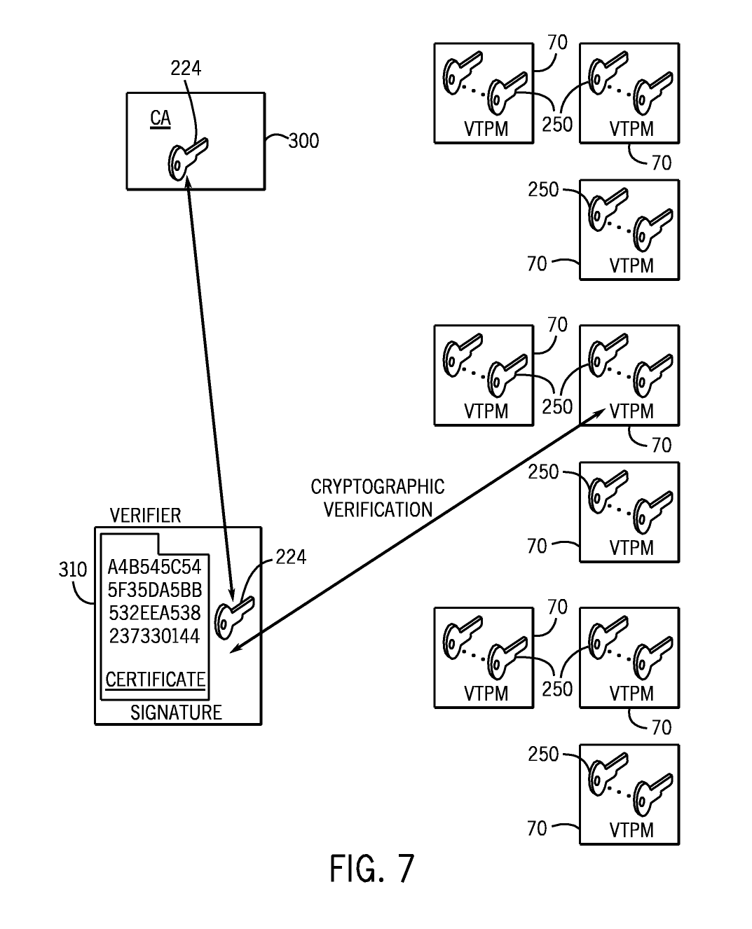

Virtual TPMs 70 existing within a cloud environment may attest for their associated virtual machines using the supervisor key signed AICs. The AICs are rooted back to the group public identity key that is published by the hardware manufacturer. FIG. 7 depicts how an AIC held by a virtual TPM 70 in the cloud is rooted back to a CA 300, which may be, for example, the hardware manufacturer. For this example, a verifier 310 uses a public group identity key 224 provided by the CA 300 to verify the AIC that is provided by a given virtual TPM 70.

In accordance with some implementations, the private group identity key 210 is a single key, which the DAA issuer 220 (see FIG. 4) provides to the virtual TPM supervisor 74. In other words, the private group identity key 210 is the same key used for the platform and for signing virtual TPM 70 certificates. In further implementations, the DAA issuer 220 may provide multiple private group identity keys 210: a private platform key as well as a separate private supervisor signing key. The latter implementation allows independent revocation of the supervisor and platform keys.

For implementations in which a single private group identity key is provided by the DAA issuer 220, a modification to a secure enclave called the “quoting enclave” may be made to allow the platform key to be used as the supervisor signing key. More specifically, certain aspects of the secure enclaves architecture use relatively complex and time consuming flows, which are not well suited for implementation within micro-coded instructions. These portions may be outsourced to macrocode. In many cases, the outsourced code relies on special access to sensitive processor or platform data. More details regarding the quoting enclave may be found in PCT Publication No. WO 2011/078855 A, mentioned above.

For example, the signing may take too long for a single instruction. Therefore, a quoting enclave may be used to produce signed quotes, by granting the quoting enclave special access to the private group identity key. Enclave authentication allows specification of the additional capabilities granted to specific enclaves, such as access to the key only by the quoting enclave.

Due to the nature of the computation involved with asymmetric keys and a desire to reduce the number of instructions in the enclave leaf, a hardware-based mechanism for producing “reports” based on a symmetric key authentication key may be used; and these symmetric key based reports are converted into asymmetrically signed quotes using software, which itself is protected using an enclave. As the quoting enclave needs to be authorized to have access to the platform attestation key, the quoting enclave itself is a special purpose enclave, known as an authenticated enclave. This approach minimizes the trusted computing base (TCB) extension and does not expose the platform key.

Thus, in accordance with some implementations, the platform key may be maintained by the quoting enclave. In this manner, a quoting enclave application programming interface (API) supports the generation of supervisor signatures. In a general purpose secure enclave attestation, the calling enclave provides a targeted report to the quoting enclave, and the report is generated using a secure enclave instruction called “ENCLU[EREPORT].” The quoting enclave encryptically verifies this report was generated on the same platform that it is running on. The REPORT structure contains a 32-byte user data entry, which is supplied when the originating enclave created the report through the ENCLU[EREPORT] instruction. The enclave report also contains information about the enclave which called the ENCLU[EREPORT] instruction. This API may use the user data field to identify the object that the supervisor enclave desires to sign. The API may also authenticate through the additional fields in the REPORT structure which enclave is requesting the service and selectively approve and deny which signatures are provided. It is noted that the system provides a minimal TCB extension while eliminating the requirement for a complex supervisor key provisioning infrastructure and management, which would be used in a multiple private key system.

Further implementations may include one or more of the following.

In an example implementation, a technique includes on a physical platform, providing a supervisor to manage a lifecycle of a virtual trusted platform module and using the supervisor to sign a certificate for an attestation identity key used by the virtual trusted platform module.

In some implementations, using the supervisor to sign the certificate includes signing the certificate with a private key stored by the supervisor. The private key is paired with a public key, and the public and private keys are issued by a direct anonymous attestation issuer, which is remote from the physical platform.

In some implementations, the issuer is associated with a manufacturer of a platform chipset.

In some implementations, the private and public keys are parts of a privacy identification associated with a manufacturer of the physical platform.

In some implementations, the technique includes using the supervisor to sign certificates for a plurality of attestation identity keys that are used by a plurality of virtual platform modules using the private key.

In some implementations, the technique includes using the supervisor to sign a certificate for an attestation identity key used by another virtual trusted platform module using another private key that is stored by the supervisor.

In some implementations, the technique further includes using the supervisor to request the private key from the issuer.

In further implementations, the private key is associated with the physical platform, and using the supervisor to sign the certificate includes signing the certificate with the private key and another private key assigned to the supervisor.

In some implementations, the technique further includes on the physical platform, providing at least one additional supervisor to manage a lifecycle of at least one additional virtual trusted platform module and using the additional supervisor(s) to sign a certificate for an attestation identity key that is used by the additional virtual trusted platform module(s).

In some implementations, the technique further includes containing the supervisor within a secure enclave of the physical platform.

In some implementations, the technique further includes containing the virtual trusted platform module in the secure enclave.

In some implementations, the virtual trusted platform module is associated with an underlying physical platform module.

In some implementations, an apparatus includes a processor that is configured to perform any of the above-mentioned techniques.

In some implementations, at least one machine readable medium includes a plurality of instructions that in response to being executed on a computing device, cause the computing device to carry out any of the above-described techniques.

In some implementations, an apparatus includes processor-created secure enclaves a virtual trusted platform and a supervisor that are contained in the secure enclaves. The supervisor manages a lifecycle of the virtual trusted platform module and the supervisor, in response to a request by the virtual trusted platform, signs a certificate for an attestation identity key that is used by the virtual trusted platform module.

In some implementations, the supervisor is adapted to sign the certificate.

In some implementations, the supervisor is adapted to store a private key. The private key is paired with a public key, and the public and private keys are issued by a direct anonymous attestation issuer. The supervisor is adapted to sign the certificate using the private key.

In some implementations, the supervisor is adapted to use the certificate to anonymously prove to a verifier that the virtual trusted platform module is associated with a given manufacturer.

In some implementations, the supervisor is adapted to perform one or more of the following: provision the virtual trusted platform module, sign an attestation identification credential for the virtual trusted platform module, regulate a migration of the virtual trusted platform module and regulate retirement of the virtual trusted platform module.

While a limited number of examples have been disclosed herein, those skilled in the art, having the benefit of this disclosure, will appreciate numerous modifications and variations therefrom. It is intended that the appended claims cover all such modifications and variations.

1. A method comprising:
on a physical platform, providing a supervisor to manage a lifecycle of a virtual trusted platform module; and
using the supervisor to sign a certificate for an attestation identity key used by the virtual trusted platform module.

2. The method of claim 1, wherein using the supervisor to sign comprises signing the certificate with a private key stored by the supervisor, the private key being paired with a public key, and the public and private keys being issued by a direct anonymous attestation issuer remote from the physical platform.

3. The method of claim 2, wherein the issuer is associated with a manufacturer of a platform chipset.

4. The method of claim 2, wherein the private and public keys are parts of a privacy identification associated with a manufacturer of the physical platform.

5. The method of claim 2, further comprising:
using the supervisor to sign certificates for a plurality of attestation identity keys used by a plurality of virtual platform modules using the private key.

6. The method of claim 2, further comprising:
using the supervisor to sign a certificate for an attestation identity key used by another virtual trusted platform module using another private key stored by the supervisor.

7. The method of claim 2, further comprising:
using the supervisor to request the private key from the issuer.

8. The method of claim 2, wherein the private key is associated with the physical platform, and using the supervisor to sign comprises signing the certificate with the private key and another private key assigned to the supervisor.

9. The method of claim 1, further comprising:
on the physical platform, providing at least one additional supervisor to manage a lifecycle of at least one additional virtual trusted platform module; and
using the at least one additional supervisor to sign a certificate for an attestation identity key used by the at least one additional virtual trusted platform module.

10. The method of claim 1, further comprising:
containing the supervisor within a secure enclave of the physical platform.

11. The method of claim 10, further comprising:
containing the virtual trusted platform module in the secure enclave.

12. The method of claim 1, wherein the virtual trusted platform module is associated with an underlying physical trusted platform module.

13. (canceled)

14. At least one machine readable medium comprising a plurality of instructions that in response to being executed on a computing device, cause the computing device to:
on a physical platform, provide a supervisor to manage a lifecycle of a virtual trusted platform module; and
use the supervisor to sign a certificate for an attestation identity key used by the virtual trusted platform module.

15. An apparatus comprising:
processor-created secure enclaves;
a virtual trusted platform contained in the secure enclaves; and
a supervisor contained in the secure enclaves to manage a lifecycle of the virtual trusted platform module, the supervisor to, in response to a request by the virtual trusted platform, sign a certificate for an attestation identity key used by the virtual trusted platform module.

16. The apparatus of claim 15, wherein the supervisor is adapted to sign the certificate.

17. The apparatus of claim 15, wherein the supervisor is adapted to:
store a private key, the private key being paired with a public key, and the public and private keys being issued by a direct anonymous attestation issuer; and
sign the certificate using the private key.

18. The apparatus of claim 17, wherein the issuer is associated with a manufacturer of a platform chipset.

19. The apparatus of claim 15, wherein the supervisor is adapted to use the certificate to anonymously prove to a verifier that the physical trusted virtual trusted platform module is manufactured by a given manufacturer.

20. The apparatus of claim 15, wherein the supervisor is adapted to perform one or more of the following: provision the virtual trusted platform module, sign an attestation identification credential for the virtual trusted platform module, regulate a migration of the virtual trusted platform module and regulate retirement of the virtual trusted platform module.

21. The at least one machine readable medium of claim 14, the at least one machine readable medium storing instructions that when executed by the computing device cause the computing device to sign the certificate but use the supervisor to sign the certificate with a private key stored by the supervisor, the private key being paired with a public key, and the public and private keys being issued by a direct anonymous attestation issuer remote from the physical platform.
